(19) United States
(12) Patent Application Publication
(10) Pub. No.: US 2017/0169079 A1
(43) Pub. Date: Jun. 15, 2017

(54) METHOD AND APPARATUS FOR SECURED INFORMATION STORAGE

(71) Applicant: Nokia Technologies Oy, Espoo (FI)

(72) Inventor: Eki Petteri MONNI, Espoo (FI)

(21) Appl. No.: 15/116,132

(22) PCT Filed: Mar. 4, 2014
(86) PCT No.: PCT/FI2014/050156

§ 371 Date: Aug. 2, 2016

(51) Int. Cl. G06F 17/30; G06N 5/00

(52) U.S. Cl. CPC G06F 17/30542; G06F 17/30442; G06N 5/003; G06F 17/30103; G06F 17/30106; G06F 17/30112; G06F 17/30929; G06F 17/30935

(57) ABSTRACT

A method, apparatus and computer program, in which an experience matrix (152, EX1) is built (210) based on content. The content is searched (220) using the built experience matrix (152, EX1). References are identified (230) to one or more files potentially comprising searched content. The referenced one or more files are decrypted (230) for verifying whether searched content was present in the referenced one or more files.

### TECHNICAL FIELD

The present application generally relates to secured information storage.

### BACKGROUND

This section illustrates useful background information without admission of any technique described herein representative of the state of the art.

Modern people possess increasing amounts of digital content. While some of the digital content is ever more mundane, the developments of digital data processing and intelligent combining have also enabled very sophisticated methods for compromising privacy of users of digital information. Further still, revelations of intelligence by various governmental entities have further demonstrated how leaks may occur even if efforts were made to keep it secret. Unsurprisingly, there is an increasing demand for user-controlled encryption of digital content such that the content is never exposed in un-encrypted form to any third parties. It is thus tempting to instantly encrypt all new content with strong cryptography, especially as much of new digital content is only for possible later use.

As a downside, however, encryption of user's content may necessitate efficiently organizing the content so that any piece of information could still be found even years later. Alternatively or additionally, searching tools can be employed. In some (typically weak) encryption methods (such as constant mapping of characters to other characters), given string of text converts consistently into some other string. In such a case, the search can also be conducted on encrypted text by first similarly encrypting search term(s) and conducting the search with those. In strong encryption, a given piece of content changes in a non-constant manner and the encrypted content should either be decrypted in course of the searching or searching indexes should be created from the content prior to its encryption. Such indexes unfortunately pose a security risk as they necessarily reveal some of the information of their target files and the generation of such index files is time and resource consuming. Moreover, the computation cost of such index files' processing may become excessive especially for handheld devices when the amount of content stored by a user increases.

### SUMMARY

Various aspects of examples of the invention are set out in the claims.

According to a first example aspect of the present invention, there is provided a method comprising:

building an experience matrix based on content;

searching the content using the built experience matrix;

identifying references to one or more files potentially comprising searched content; and

subsequently decrypting the referenced one or more files for verifying whether searched content was present in the referenced one or more files.

The decrypting may be performed by entirely decrypting the referenced one or more files. Alternatively, only portions of the referenced one or more files may be decrypted to enable a user to understand context of the referenced file with regard to the searching.

The method may further comprise receiving an identification of one or more search terms. The receiving of the identification of the one or more search terms may comprise inputting the one or more search terms from a user. The search terms may comprise any of text; digits; punctuation marks; Boolean search commands; alphanumeric string; and any combination thereof.

The experience matrix may comprise a plurality of sparse vectors.

The experience matrix may be a random index matrix.

The matrix may comprise one row for each of a plurality of files that comprise the content.

The experience matrix may comprise natural language words. The experience matrix may comprise a dictionary of natural language words in one or more human languages. Alternatively or additionally, the experience matrix may comprise any one or more rows of pointers or attributes: time; location; sensor data; message; contact; universal resource locator; image; video; audio; feeling; and color.

The method may further comprise semantic learning of the content from the experience matrix.

The use of sparse vectors may be configured to maintain the matrix nearly constant-sized such that memory consumption of searching content does not significantly increase on increasing the content by hundreds of files.

The sparse vectors may comprise at most 10% of non-zero elements. The sum of elements of each sparse vector may be zero.

The content may be encrypted after the building of the experience matrix.

The building of the experience matrix may be performed to enable using a predictive experience index algorithm to search the experience matrix. The predictive experience index algorithm may be Kanerva's random index algorithm.

The searching of the content may be performed while keeping the content encrypted. The referenced one or more files may be decrypted after completion of the searching using the built random index matrix.

The experience matrix may be encrypted after or on building thereof.

The experience matrix may be decrypted for the searching of the content.

According to a second example aspect of the present invention, there is provided an apparatus comprising a processor configured to:

build an experience matrix based on content;
search the content using the built experience matrix; and
identify references to one or more files potentially comprising searched content.

The processor may be further configured to decrypt the referenced one or more files for verifying whether searched content was present in the referenced one or more files.

According to a third example aspect of the present invention, there is provided an apparatus, comprising:

at least one processor; and

at least one memory including computer program code;

the at least one memory and the computer program code configured to, with the at least one processor, cause the apparatus to perform at least the following:
building an experience matrix based on content;
searching the content using the built experience matrix; and
identifying references to one or more files potentially comprising searched content.

The at least one memory and the computer program code may be further configured to, with the at least one processor, cause the apparatus to perform decrypting of the referenced one or more files for verifying whether searched content was present in the referenced one or more files.

According to a fourth example aspect of the present invention, there is provided a computer program, comprising:

code for building an experience matrix based on content;

code for searching the content using the built experience matrix; and

code for identifying references to one or more files potentially comprising searched content;

when the computer program is run on a processor.

The computer program may further comprise code for decrypting the referenced one or more files for verifying whether searched content was present in the referenced one or more files;

when the computer program is run on the processor.

The computer program may be stored on a computer-readable memory medium. The memory medium may be non-transitory. Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of an apparatus of an example embodiment of the invention;

FIG. 2 shows a flow chart illustrating a process of an example embodiment of the invention; and

FIG. 3 shows a system configured to gather and process data by using an experience matrix,

FIG. 4 shows a sparse vector supply comprising a word hash table and a group of basic sparse vectors,

FIG. 5 shows a sparse vector supply comprising a group of basic sparse vectors, and

FIG. 6 shows a sparse vector supply comprising a random number generator configured to generate basic sparse vectors.

### DETAILED DESCRIPTION OF THE DRAWINGS

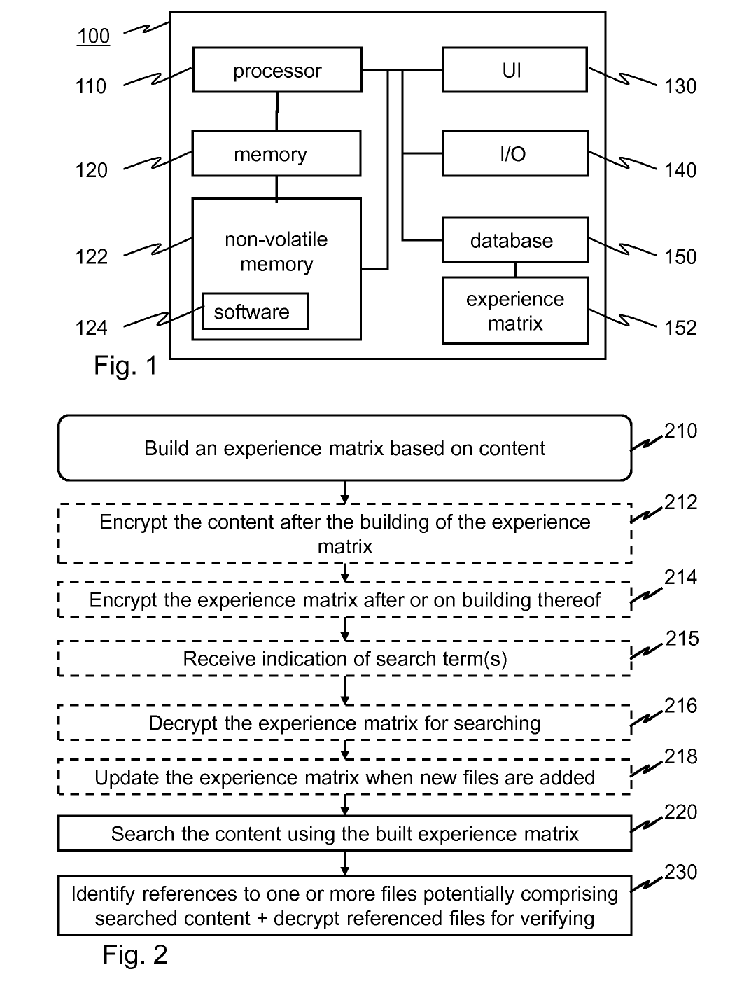

An example embodiment of the present invention and its potential advantages are understood by referring to FIGS. 1 through 6.

FIG. 1 shows a block diagram of an apparatus 100 of an example embodiment of the invention. The apparatus is in some example embodiments a small electronic device such as a mobile telephone, handheld gaming device, electronic digital assistant, and/or digital book, for example. The apparatus 100 comprises a processor 110, a memory 120 for use by the processor to control the operation of the apparatus 100 and a non-volatile memory 122 for storing long-term data such as software 124 comprising an operating system and computer executable applications. The apparatus 100 further comprises a user interface 130 for user interaction, an input/output system 140 for communication with internal and external entities such as one or more mass memories and networked entities. Moreover, the apparatus 100 itself comprises or is configured to access a remotely located database 150 that comprises an experience matrix 152.

FIG. 2 shows a flow chart illustrating a process of an example embodiment of the invention. The process comprises:

building 210 an experience matrix based on content;

searching 220 the content using the built experience matrix; and

identifying 230 references to one or more files potentially comprising searched content and subsequently decrypting the referenced one or more files for optionally verifying whether searched content was present in the referenced one or more files.

In an example embodiment, the experience matrix comprises a plurality of sparse vectors.

In an example embodiment, the experience matrix is a random index matrix.

In an example embodiment, the experience matrix comprises one row for each of a plurality of files that comprise the content.

In an example embodiment, the process further comprises semantic learning of the content from the experience matrix.

In an example embodiment, the experience matrix comprises natural language words. In an example embodiment, the experience matrix comprises a dictionary of natural language words in one or more human languages. In an example embodiment, the experience matrix comprises any one or more rows of pointers or attributes: time; location; sensor data; message; contact; universal resource locator; image; video; audio; feeling; and color. In an example embodiment, such further one or more rows can be used in semantic learning of the documents through the experience matrix.

In an example embodiment, the use of sparse vectors is configured to maintain the matrix nearly constant-sized such that memory consumption of searching content does not significantly increase on increasing the content by hundreds of files.

In an example embodiment, the sparse vectors comprise at most 10% of non-zero elements. In an example embodiment, the sum of elements of each sparse vector is zero.

In an example embodiment, the process further comprises encrypting 212 the content after the building of the experience matrix.

In an example embodiment, the building 210 of the experience matrix is performed to enable using a predictive experience index algorithm to search the experience matrix.

In an example embodiment, the process further comprises receiving an identification of one or more search terms, 215. The receiving of the identification of the one or more search terms may comprise inputting the one or more search terms from a user. The search terms may comprise any of text; digits; punctuation marks; Boolean search commands; alphanumeric string; and any combination thereof.

In an example embodiment, the searching 220 of the content is performed while keeping the content encrypted.

In an example embodiment, the process further comprises decrypting 230 the referenced one or more files after completion of the searching using the built random index matrix. In an example embodiment, the decrypting is performed by entirely decrypting the referenced one or more files. Alternatively, only portions of the referenced one or more files can be decrypted to enable a user to understand context of the referenced file with regard to the searching.

In an example embodiment, the process further comprises encrypting 214 the experience matrix after or on building thereof.

In an example embodiment, the experience matrix is decrypted 216 for the searching of the content.

In an example embodiment, the experience matrix is updated 218 when new files are added. In an example embodiment, the experience matrix is also updated 218 when files are deleted or updated. For example, when a new file is added, a corresponding new row is added to the experience matrix by adding a random index RI for new row. Where the content is text, plain language words and other relations are activated for referring words.

In an example embodiment, the experience matrix with the random index or RI matrix contains:
One row representing different natural language words, such as: dog, cat and mouse;
a reference as one row for each file such as word processor file, presentation file, e-mail message, downloaded web page, address book contact, etc.

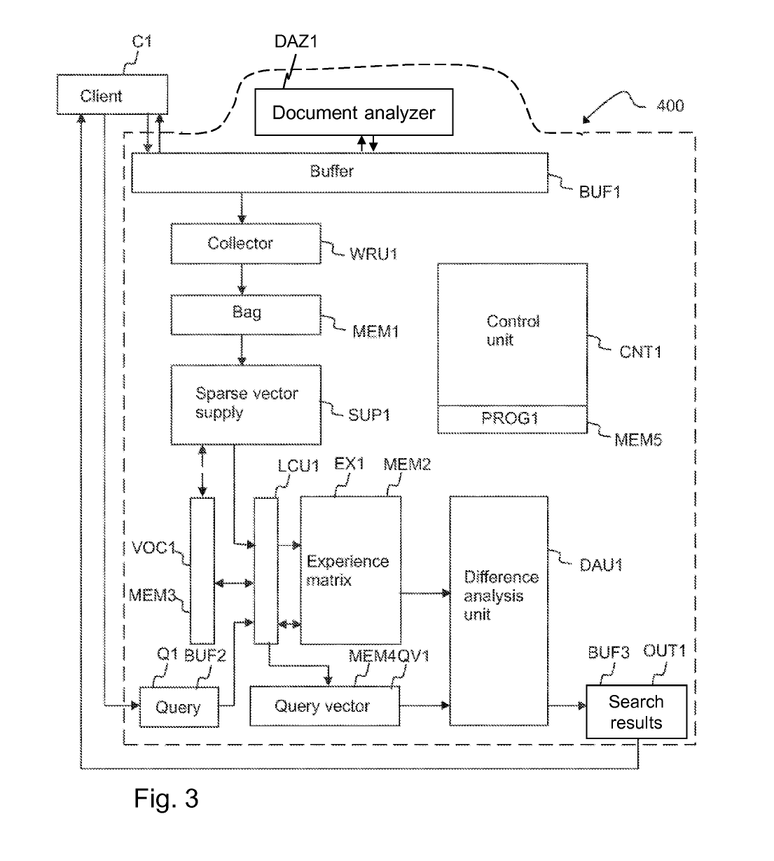

Generally speaking, for semantic learning, there could be any types of properties (e.g. attributes or pointers) of documents for use in the searching. Such properties may include, for example, any of: color, color distribution, feeling, time, location, movement, universal resource locator, image, audio, video. Such properties are obtainable through document analysis by the document analyzer (DAZ1 in FIG. 3). For example, a genre of audible and/or visible content can be determined based on its rhythm and other automatically detectable and in some cases, files readily comprise metadata that in itself can be used for determining further attributes relating to feelings that the content in question is likely relating to.

The reference is e.g. a reference to the corresponding encrypted file, e.g. formatted as file://3406972346239; msg://349562349562; pointer to an exact location inside a file (for example, to an e-mail message within mailbox file); or contact://356908704952.

Columns of the RI matrix are sparse vectors. Hence, the RI matrix provides fast search times, substantially constant (only slightly changing on addition of a new file to the content) or non-increasing memory usage, and efficient processing and small energy demand and suitability for use in resource constrained devices.

Some examples on experience matrices and their use for predictive search of data are presented in the following with reference to FIGS. 3 to 6.

FIG. 3 shows a subsystem 400 for processing co-occurrence data (e.g. data from documents to be indexed). The subsystem 400 is set to store co-occurrence data in an experience matrix EX1. The subsystem 400 is configured to provide a prediction (i.e. search results) based on co-occurrence data stored in the experience matrix EX1.

The subsystem 400 comprise a buffer BUF1 for receiving and storing words, a collecting unit WRU1 for collecting words to a bag, a memory MEM1 for storing words of the bag, a sparse vector supply SUP1 for providing basic sparse vectors, memory MEM3 for storing the vocabulary VOC1, the vocabulary stored in the memory MEM3, a combining unit LCU1 for modifying vectors of the experience matrix EX1 and/or for forming a query vector QV1, a memory MEM2 for storing the experience matrix EX1, the experience matrix EX1 stored in the memory MEM2, a memory MEM4 for storing the query vector QV1, and/or a difference analysis unit DAU1 for comparing the query vector QV1 with the vectors of the experience matrix EX1. The subsystem 400 further comprises a document analyzer DAZ1. The document analyzer DAZ1 is in an example embodiment a software based functionality (hardware accelerated in another example embodiment). The document analyzer DAZ1 is configured to automatically analyze files received from the client C1 e.g. by any of the following:
recognizing objects that appear in image or video files (e.g. vehicles, animals, people, landscape, constructions);
recognizing faces that appear in image or video files;
identifying ambient light temperature of image or video;
identifying likely associated feelings from image or video files (e.g. detecting direction of corners of mouths, identifying tears and detecting tempo of events in video image);
recognizing one or more persons by voice detection;
identifying tone of texts (e.g. by corpus analysis and/or determining average length of sentences and/or use of punctuation).

In an example embodiment, the subsystem 400 comprises a buffer BUF2 and or a buffer BUF3 for storing a query Q1 and/or a search results OUT1. The words are received e.g. from a user client C1 (a client machine that is e.g. software running on the apparatus 100). The words may be collected to individual bags by a collector unit WRU1. The words of a bag are collected or temporarily stored in the memory MEM1. The contents of each bag are communicated from the memory MEM1 to a sparse vector supply SUP1. The sparse vector supply SUP1 is configured to provide basic sparse vectors for updating the experience matrix EX1.

The contents of each bag and the basic sparse vectors are communicated to a combining unit LCU1 that is configured to modify the vectors of the experience matrix EX1 (e.g. by forming a linear combination). The combining unit LCU1 is configured to add basic sparse vectors to target vectors specified by the words of each bag. In an example embodiment, the combination unit LCU1 is arranged to execute summing of vectors at the hardware level. Electrical and/or optical circuitry of the combination unit LCU1 are arranged to simultaneously modify several target vectors associated with words of a single bag. This may allow high data processing rate. In another example embodiment, software based processing is applied.

The experience matrix EX1 is stored in the memory MEM2. The words are associated with the vectors of the experience matrix EX1 by using the vocabulary VOC1 stored in the memory MEM3. Also the vector supply SUP1 is configured to use the vocabulary VOC1 (or a different vocabulary) e.g. in order to provide basic sparse vectors associated with words of a bag.

The subsystem 400 comprises the combining unit LCU1 or a further combining unit configured to form a query vector QV1 based words of a query Q1. They query vector QV1 is formed as a linear combination of vectors of the experience matrix EX1. The locations of the relevant vectors of the experience matrix EX1 are found by using the vocabulary VOC1. The query vector QV1 is stored in the memory MEM4.

The difference analysis unit DAU1 may be configured to compare the query vector QV1 with vectors of the experience matrix EX1. For example, the difference analysis unit DAU1 is arranged to determine a difference between a vector of the experience matrix EX1 and the query vector QV1. The difference analysis unit DAU1 is further arranged to sort differences determined for several vectors. The difference analysis unit DAU1 is configured to provide search results OUT1 based on said comparison. Moreover, a quantitative indication can be provided such as a ranking or other indication of how well the search criterion or criteria is/are matching with the searched content. The quantitative indication may be a percentage. The quantitative indication can be obtained directly from calculating Euclidean distance between two sparse vectors, for example. The query words Q1, Q2 itself can be excluded from the search results.

In an example embodiment, the difference analysis unit DAU1 are arranged to compare the vectors at hardware level. Electrical and/or optical circuitry of the combination unit LCU1 can be arranged to simultaneously determine quantitative difference descriptors (DV) for several vectors of the experience matrix EX1. This may allow high data processing rate. In another example embodiment, software based processing is applied.

The subsystem 400 comprises a control unit CNT for controlling operation of the subsystem 400. The control unit CNT1 comprises one or more data processors. The subsystem 400 comprises a memory MEM 5 for storing program code PROG1. The program code PROG1 may be used for carrying out the process of FIG. 2, for example. Words are received e.g. from the client C1. The search results OUT1 are communicated to the client C1. The client C1 may also retrieve system words from the buffer BUF1 e.g. in order to form a query Q1.

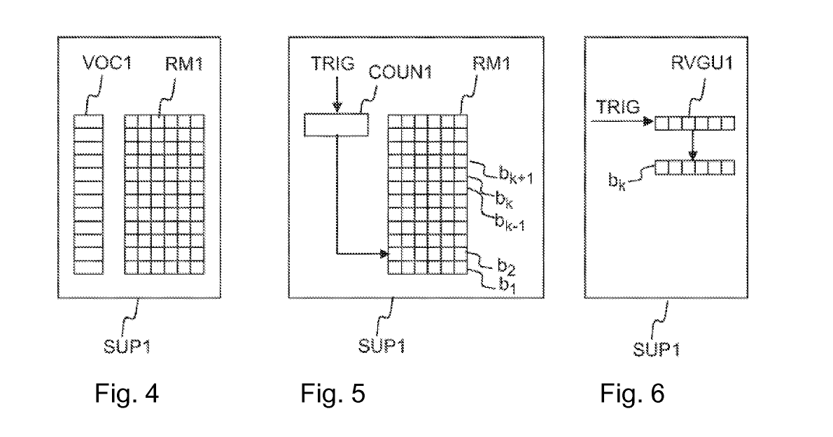

Referring to FIGS. 3 and 4, the sparse vector supply SUP1 may provide a sparse vector e.g. by retrieving a previously generated sparse vector from a memory (table) and/or by generating the sparse vector in real time. The sparse vector supply SUP1 comprises a memory for storing basic sparse vectors a₁, a₂, . . . aₙ associated with words of the vocabulary VOC1. The basic sparse vectors a₁, a₂, . . . aₙ form the basic sparse matrix RM1. The basic sparse vectors a₁, a₂, . . . aₙ can be previously stored in a memory of the sparse vector supply SUP1. Alternatively, or in addition, an individual basic sparse vector associated with a word can be generated in real time when said word is used for the first time in a bag. The basic sparse vectors are generated e.g. by a random number generator. Referring to FIGS. 3 and 5, the sparse vector supply SUP1 may comprise a memory (not shown) for storing a plurality of previously determined basic sparse vectors bᵢ, b₂, . . . . When a new bag arrives, a trigger signal is generated, and a count value of a counter is changed. Thus a next basic sparse vector is retrieved from a location of the memory indicated by the counter. Thus, each bag will be assigned a different basic sparse vector. The same basic sparse vector may represent each word of said bag.

Referring to FIG. 6, a new basic sparse vector bₖ can be generated by a random number generator RVGU1 each time when a new bag arrives. Thus, each bag will be assigned a different basic sparse vector (the probability of generating two identical sparse vectors will be negligible). The same basic sparse vector may represent each word of said bag.

Without in any way limiting the scope, interpretation, or application of the claims appearing below, a technical effect of one or more of the example embodiments disclosed herein is that substantially constant amount of memory is needed while more files are added to the content that is being searched. Another technical effect of one or more of the example embodiments disclosed herein is that substantially constant amount of processing is needed while more files are added to the content that is being searched. Another technical effect of one or more of the example embodiments disclosed herein is that content such as files and e-mails can be continuously stored in an encrypted form on the storage device while performing searching thereon. Another technical effect of one or more of the example embodiments disclosed herein is that handling of particularly large files (such as encrypted e-mail mailbox files) may be greatly enhanced. Another technical effect of one or more of the example embodiments disclosed herein is that handling of encrypting content may be enhanced: for example, users may avoid using encrypted e-mail, if it is too difficult to search stored email within a large encrypted file such as the mailbox. Another technical effect of one or more of the example embodiments disclosed herein is that for accessing search hits, the whole content need not be decrypted. Another technical effect of one or more of the example embodiments disclosed herein is that probability of a search hit can also be estimated. Another technical effect of one or more of the example embodiments disclosed herein is that using random index for search may return both traditional word-by-word matching (non-semantic) results, but also semantic results, thanks to the semantic learning. For example: In a traditional search case, if a document in the content contains word “dog”, this document is identified, if searched for “dog”. Moreover, in semantic searching, exact word-to-word match is not required: the system may adapt itself by learning from added documents. For instance, a first document may describe animals generally without any express reference to dogs whereas a second document may define that a dog is an animal. Based on this information, the system may adapt by learning such that on searching dogs, the second document is identified and also the first document is identified. In an example embodiment, both types of search results are simultaneously produced (express matching and semantic hits).

Embodiments of the present invention may be implemented in software, hardware, application logic or a combination of software, hardware and application logic. The software, application logic and/or hardware may reside on persistent memory, work memory or transferrable memory such as a USB stick. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1-20. (canceled)

21. A method comprising:
building an experience matrix based on content;
searching the content using the built experience matrix;
identifying references to one or more files potentially comprising searched content; and
decrypting the referenced one or more files for verifying whether searched content was present in the referenced one or more files.

22. The method of claim 21, wherein the experience matrix comprises a plurality of sparse vectors.

23. The method of claim 22, wherein the sparse vectors comprises at most 10% of non-zero elements.

24. The method of claim 22, wherein the sum of elements of each sparse vector may be zero.

25. The method of claim 21, wherein the decrypting is performed by entirely decrypting the referenced one or more files.

26. The method of claim 21, wherein only portions of the referenced one or more files are decrypted to enable a user to understand context of the referenced file with regard to the searching.

27. The method of claim 21, further comprising receiving an identification of one or more search terms.

28. The method of claim 27, wherein the receiving of the identification of the one or more search terms comprises inputting the one or more search terms from a user.

29. The method of claim 21, wherein the experience matrix is a random index matrix.

30. The method of claim 21, wherein the matrix comprises one row for each of a plurality of files that comprise the content.

31. The method of claim 21, further comprising encrypting the content after the building of the experience matrix.

32. The method of claim 21, wherein the building of the experience matrix is performed using a predictive experience index algorithm.

33. The method of claim 21, further comprising decrypting the referenced one or more files after completion of the searching the content using the built experience matrix.

34. The method of claim 21, further comprising encrypting the experience matrix after or on building thereof.

35. The method of claim 21, further comprising decrypting the experience matrix for the searching of the content.

36. An apparatus, comprising:
a processor configured to:
build an experience matrix based on content;
search the content using the built experience matrix;
identify references to one or more files potentially comprising searched content; and
decrypt the referenced one or more files for verifying whether searched content was present in the referenced one or more files.

37. The apparatus of claim 36, wherein the wherein the experience matrix comprises a plurality of sparse vectors.

38. The apparatus of claim 37, wherein the sparse vectors comprises at most 10% of non-zero elements.

39. The apparatus of claim 36, wherein the decrypting is performed by entirely decrypting the referenced one or more files.

40. The apparatus of claim 36, wherein only portions of the referenced one or more files are decrypted to enable a user to understand context of the referenced file with regard to the searching.
